(19) United States
(12) Patent Application Publication
(10) Pub. No.: US 2009/0178238 A1
(43) Pub. Date: Jul. 16, 2009

(54) HINGE BARREL FOR FOLDABLE ELECTRONIC DEVICE

(75) Inventor: DIAN-HONG WEI, Shenzhen City (CN)

Correspondence Address: PCE INDUSTRY, INC.;ATT. Steven Reiss, 458 E. LAMBERT ROAD, FULLERTON, CA, 92835, US

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/198,976

(22) Filed: Aug. 27, 2008

(30) Foreign Application Priority Data
Jan. 14, 2008 (CN) 200810300092.X

(51) Int. Cl. E05D 7/00

(52) U.S. Cl. 16/221

(57) ABSTRACT

A hinge barrel (30) is mounted in a housing of a portable electronic device (20). The housing defines a receiving hole (222) surrounded by an inner wall (223). The inner wall defines two grooves (226). The hinge barrel includes an outer peripheral wall (35), and two ribs (38) formed in the outer peripheral wall. A length of the ribs is less than that of the hinge barrel, and the ribs are received in the grooves.

### BACKGROUND

1. Field of the Invention

The present invention relates to a hinge apparatus and, particularly, to a hinge barrel used for receiving a hinge assembly for foldable electronic devices such as mobile phones, foldable computers, etc.

2. Description of Related Art

Foldable electronic devices usually have a hinge that connects a body section and a cover section. The hinge generally includes a hinge barrel and a hinge assembly received in the barrel.

Referring to FIG. 3, the hinge barrel 10 is substantially cylindrical, and forms two spaced projection blocks 14 in an outer peripheral wall 12 thereof. The barrel 10 is engaged in a body section of a foldable electronic device. The body section defines a receiving hole at an end thereof. The receiving hole is surrounded by an inner wall. The inner wall defines two grooves configured for receiving the projection blocks 14 to make a non-rotatable connection between the body section and the hinge barrel 10. However, since the two projection blocks 14 are at one side of the hinge barrel 10, the area on which forces act is small, resulting in large stresses. Therefore, the inner wall of the receiving hole can easily be damaged.

Therefore, there is room for improvement in the art.

### BRIEF DESCRIPTION OF THE DRAWINGS

Many aspects of the present hinge barrel can be better understood with reference to the following drawings. The components in the drawings are not necessarily drawn to scale, the emphasis instead being placed upon clearly illustrating the principles of the present hinge barrel. Moreover, in the drawings, like reference numerals designate corresponding parts throughout the several views, in which:

FIG. 1 is an exploded, isometric view of a hinge barrel and a portion of a foldable electronic device;

FIG. 2 is an enlarged view of the hinge barrel shown in FIG. 1; and

FIG. 3 is an isometric view of a conventional hinge barrel.

### DETAILED DESCRIPTION OF THE EMBODIMENTS

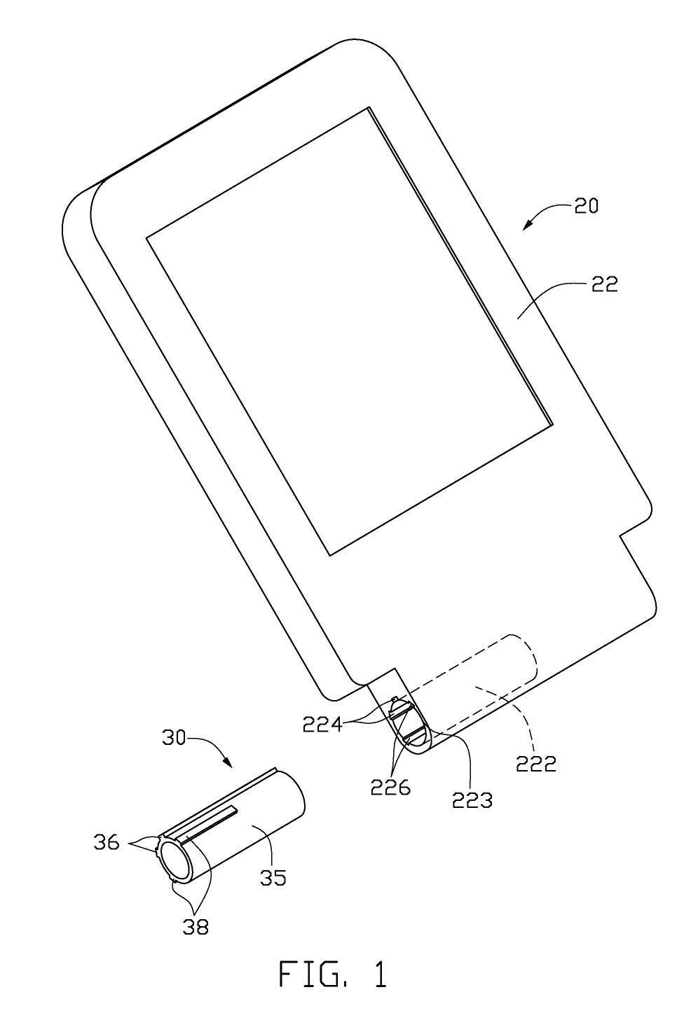

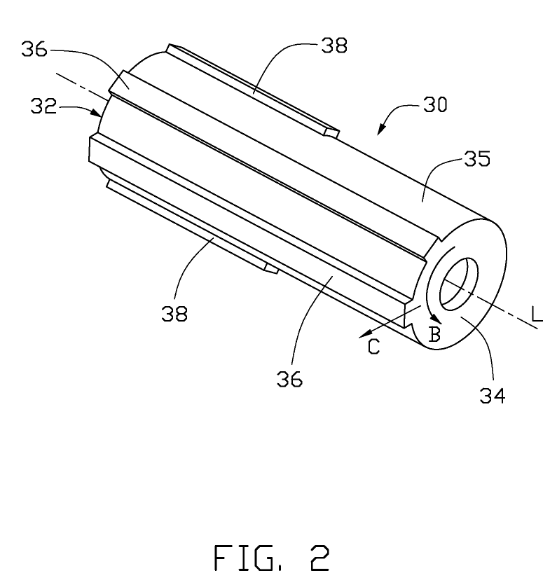

FIGS. 1 and 2 show a foldable electronic device 20 including a housing 22 and a hinge barrel 30. The hinge barrel 30 receives a hinge assembly (not shown).

The housing 22 defines a receiving hole 222. The receiving hole 222 is surrounded by an inner circumferential wall 223. The inner circumferential wall 223 defines two slots 224 and two grooves 226. Each slot 224 extends the length of the receiving hole 222. The grooves 226 are symmetric with a central axis of the receiving hole 222. The two slots 224 are at one side of the two grooves 226. Each groove 226 extends about half the length of the receiving hole 222.

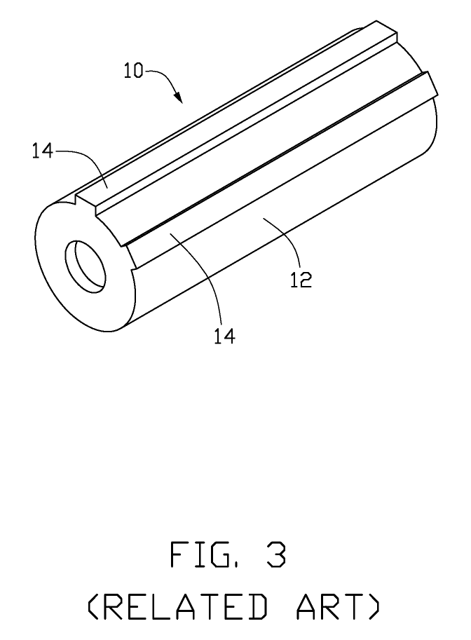

The hinge barrel 30 is a hollow cylinder, and includes a first end 32, a second end 34, and an outer circumferential wall 35. The outer circumferential wall 35 forms two spaced projection blocks 36. Each projection block 36 extends from the first end 32 of the hinge barrel 30 to the second end 34 of the hinge barrel 30 along a central axis (arrow L of FIG. 3) of the hinge barrel 30. Each projection block 36 is configured for engaging a corresponding slot 224 to interlock the housing 22 and the hinge barrel 30 so they can rotate together. The outer circumferential wall 35 further forms two ribs 38 symmetric to a central axis L. Each rib 38 extends from the first end 32 of hinge barrel 30 to the half length point of the hinge barrel 30, and configured for engaging in a corresponding groove 226.

During assembly of the hinge barrel 30, the hinge barrel 30 is received in the receiving hole 222 of the housing 22. The projection blocks 36 are received in the slots 224. The engagement relationship between the projection blocks 36 and the slots 224 is a transition fit along a circumferential direction as shown in B arrow, and the engagement relationship is a clearance fit or a transition fit along a radial direction as shown in C arrow. The ribs 38 are receiving in the grooves 226. The engagement relationship between the ribs 38 and the grooves 226 is a transition fit along a circumferential direction as shown in B arrow, and the engagement relationship is an interference fit along a radial direction as shown in C arrow. The interference fit means a largest limit size of a hole is smaller than a smallest limit size of a shaft. The clearance fit means a smallest limit size of a hole is larger than a largest limit size of a shaft. The transition fit is at between the clearance fit and the interference fit, and a hole tolerance band with a shaft tolerance band is overlapped.

Since the ribs 38 are at two sides of the projection blocks 36, the stressed area of the inner wall 223 is increased. The interference fit along a radial direction between the ribs 38 and the grooves 226 may limit the relative movement therebetween. The length of the ribs 38 only extends one part of the total length of the hinge barrel 30. Therefore, the ribs 38 do not excessively press the inner wall 223 of the receiving hole 222. The transition fit along a circumferential direction between the projection blocks 36 and the slots 224, between the ribs 38 and the grooves 226 may avoid producing noise.

Understandably, the extending length of the rib 38 may only extend one part of the total length of the hinge barrel.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention and the actual scope of the invention being defined by the appended claims.

What is claimed is:

1. A hinge barrel mounted in a housing of a portable electronic device, the housing defining a receiving hole surrounded by an inner wall, the inner wall defining two grooves, the hinge barrel comprising an outer peripheral wall and two ribs formed in the outer peripheral wall, wherein a length of the ribs is less than the length of the hinge barrel, and the ribs are received in the grooves.

2. The hinge barrel as claimed in claim 1, wherein the engagement between the rib and the groove along a radial direction of the hinge barrel is an interference fit.

3. The hinge apparatus as claimed in claim 2, wherein a length of the rib is about half of the length of the hinge barrel.

4. The hinge apparatus as claimed in claim 1, wherein the hinge barrel includes two projection blocks, the projection blocks are positioned at one side of the two ribs, the inner wall defines two slots, and the projection blocks are received in the slots.

5. The hinge apparatus as claimed in claim 4, wherein the engagement relationship between the projection blocks and the slots is a transition fit along a circumferential direction, and the engagement relationship is a clearance fit or a transition fit along a radial direction.

6. A foldable electronic device comprising:
a housing defining a receiving hole surrounded by an inner wall thereof; the inner wall defining two grooves and two slots;
a hinge barrel comprising an outer peripheral wall and two ribs and two projection blocks formed in the outer peripheral wall, the ribs engaged in the grooves and the projection blocks engaged in the slots, a length of the ribs is less than the length of the hinge barrel, and the ribs are received in the grooves, a length of the projection blocks is equal to the length of the hinge barrel.

7. The foldable electronic device as claimed in claim 6, wherein the engagement between the rib and the groove along a radial direction of the hinge barrel is an interference fit.

8. The foldable electronic device as claimed in claim 6, wherein the engagement relationship between the projection blocks and the slots is a transition fit along a circumferential direction, and the engagement relationship is a clearance fit or a transition fit along a radial direction.

9. The foldable electronic device as claimed in claim 6, wherein a length of the rib is about half of the length of the hinge barrel.
